(19) United States
(12) Patent Application Publication
(10) Pub. No.: US 2024/0007504 A1
(43) Pub. Date: Jan. 4, 2024

(54) Analyzing device configuration data to check for network compliance

(71) Applicant: Ciena Corporation, Hanover, MD (US)

(72) Inventors: Thomas Triplet, Manotick (CA); Sudhan Puranik, Pune (IN); Sachin Saswade, San Jose, CA (US)

(21) Appl. No.: 17/948,268

(22) Filed: Sep. 20, 2022

(30) Foreign Application Priority Data
Jul. 1, 2022 (IN) 202211038053

(51) Int. Cl. H04L 9/40; H04L 41/0866; G06N 20/00

(52) U.S. Cl. CPC H04L 63/20; H04L 41/0866; G06N 20/00

(57) ABSTRACT

Systems, methods, and Machine Learning (ML) techniques are provided for detecting changes to configuration information associated with network devices and determining if the changes are network compliant. A method, according to one implementation, includes the step of fetching configuration data associated with a Network Element (NE) to be monitored. Based on detection of a configuration difference (config diff), whereby the configuration data has changed with respect to previously-stored configuration information, the method further includes the step of monitoring the configuration data to determine if the configuration data conforms to predetermined compliance rules and policies.

### TECHNICAL FIELD

The present disclosure generally relates to networking systems and methods. More particularly, the present disclosure relates to systems, methods, and Machine Learning (ML) techniques for monitoring configuration data with respect to a number of Network Elements (NEs) and determining if the configuration data meets certain network compliance criteria.

### BACKGROUND

One significant goal in the field of network management is the monitoring of network devices to ensure that they are compliant with respect to various criteria, such as trust, reputation, legality, integrity, security, etc. Based on past observations, an enterprise network determined to be non-compliant can incur a number of different types of penalties or breach costs, such as fines or even lawsuits. For this reason, the issue of monitoring compliance is a high priority for network operators who manage these enterprise networks to make sure that every device in the network is network compliant and secure in order to avoid data breaches.

Per industry analysts, about 80% of security issues result from misconfiguration of network devices, where “misconfiguration” may refer to improper configuration data (config data) of the devices. Regarding the actions of monitoring and changing device configuration data, about 68% of current Information Technology (IT) staff still used conventional Command Line Interfaces (CLIs). However, such human-based IT activities are error-prone and typically slow down the overall resolution process. Moreover, with a growing number of multi-vendor devices in a network, manually adjusting configuration data is practically unscalable. Even when devices are compliant when they are originally provisioned, their configuration data will typically be modified over time and often will not remain network compliant as these configurations might tend to “drift” over time.

Generally, conventional configuration management products are able to offer compliance solutions, which are adapted to run on network devices and are executed within an ad-hoc or scheduled timeframe. Some devices (e.g., firewalls) have the capability of performing compliance checks at the device level itself, but these conventional devices normally have limitations. Also, conventional tools may even be able to provide remediation action in addition to along a compliance check.

However, efforts required to craft rules and policies with respect to compliance are normally performed by network operators using conventional manual processes. Also, after executing a compliance check and determining that modifications to the configuration data is needed, network operators are typically required to enter user input to remediate issues in non-compliant devices, which of course is a time consuming task and ever increases as a network scales. Therefore, there is a need in the field of networking systems, particularly with respect to configuration data and compliance monitoring, to provide systems and methods that overcome the above-mentioned deficiencies of the conventional systems.

### BRIEF SUMMARY

The present disclosure focuses on various systems and methods for monitoring compliance of configuration changes in Network Elements (NEs) deployed in a communications network (e.g., enterprise network). A process, in accordance with various implementations, may include a step of fetching configuration data associated with a NE to be monitored. Based on detection of a configuration difference, whereby the configuration data has changed with respect to previously-stored configuration information, the process may further include the step of monitoring the configuration data to determine if the configuration data conforms to predetermined compliance rules and policies.

According to additional embodiments, the step of fetching the configuration data may be executed in response to receiving a trigger. For example, the trigger may be a) a real-time trigger involving observing user behavior with respect to the NE to be monitored, b) an on-demand trigger in which the user requests a compliance check, and/or c) a scheduled trigger in which compliance checks are performed at regularly scheduled times.

In response to determining that the configuration data is non-compliant, the process may further include the step of automatically performing one or more remediation actions on the configuration data to reach a compliant state. Alternatively, in response to determining that the configuration data is non-compliant, the process may instead provide one or more recommendations to a network operator regarding remediation actions.

In some embodiments, the process may utilize Machine Learning (ML) techniques to train a ML model to establish or modify the predetermined compliance rules and policies. Also, the process may include utilizing ML techniques to perform one or more functions including a) monitoring the configuration data of multiple NEs, b) synchronizing configuration files between two or more of the multiple NEs, c) calculating the configuration difference, d) performing compliance checks, e) performing remediation actions for non-compliant NEs, and/or f) providing remediation recommendations to a user.

Furthermore, the process may also include the steps of establishing compliance rules and policies for a plurality of NEs in a network and defining an intent to perform compliance monitoring with respect to the compliance rules and policies. If the configuration data does not conform to the predetermined compliance rules and policies, the process may determine the type and severity of the non-compliance. The process may be associated with a system and/or non-transitory computer-readable media. In some embodiments, this system may include a processing device and memory and may perform the functions or steps of the process. Also, the system may further include a database configured to store configuration information and/or compliance information.

### BRIEF DESCRIPTION OF THE DRAWINGS

The present disclosure is illustrated and described herein with reference to the various drawings. Like reference numbers are used to denote like components/steps, as appropriate. Unless otherwise noted, components depicted in the drawings are not necessarily drawn to scale.

FIG. 1 is a block diagram illustrating a computer system adapted to monitor configuration data of a number of Network Elements (NEs) and determine if the configuration data is compliant with respect to trust, reputation, legality, integrity, and security criteria, according to various embodiments of the present disclosure.

FIGS. 2A and 2B, in combination, form a flow diagram illustrating a process for monitoring for compliance, according to various embodiments.

FIG. 3 is a diagram illustrating a process flow for monitoring compliance and applying remediations, according to various embodiments.

FIG. 4 is a diagram illustrating a system for collecting data with respect to configuration data of a number of NEs and determining compliance of the configuration data, according to various embodiments.

FIG. 5 is a diagram illustrating a process flow for comparing config data with baseline config data based in response to different triggers, according to various embodiments.

FIG. 6 is a table illustrating remediation actions based on a pass or fail compliance check, according to various embodiments.

FIG. 7 is a flow diagram illustrating a general process for monitoring compliance of configuration changes in NEs, according to various embodiments.

### DETAILED DESCRIPTION

The present disclosure relates to systems and methods for monitoring various parameters of Network Elements (NEs) of a communications network. For example, the NEs may be routers, switches, firewalls, load balancers, virtual devices, cloud workloads, Virtual Private Cloud (VPC) devices, etc. The monitored parameters may include, for example, configuration (config) data that may be associated with each NE. In addition, other parameters besides config data may also be monitored. For example, the systems and methods of the present disclosure may also monitor End-of-Life (EoL) parameters, vendor notifications, license expiration, firmware version numbers, Virtual Private Cloud (VPC) configs, etc. Although the present systems and methods may be able to monitor a number of different types of NE parameters, characteristics, metrics, etc., the embodiments described in the present disclosure, for simplicity, are directed to the monitoring of config data of the NEs.

As config data on a NE may be changed on a regular basis (e.g., using firmware updates, etc.), a network operator will normally attempt to make sure that the config data is compliant with various network criteria. As mentioned above, meeting network compliance may be a critical goal to avoid a violation of breach in trust, reputation, integrity, legality, security, regulatory, operational, and/or other possible types of compliance concerns. Since non-compliance can result in fines, penalties, lawsuits, etc., it would behoove an administrator or technician associated with a network (e.g., enterprise network) to detect when a NE is non-compliant and/or if a proposed config change may result in non-compliance. By detecting non-compliance, automated changes can be made in order to avoid various types of data or service violations.

Instead of relying on manual changes to NE misconfigurations, the systems and methods of the present disclosure are configured to perform automated monitoring, compliance checks, and remediation. In some cases, remediation may be performed manually by a network operator in response to automated recommendations and/or remediation may be performed automatically when pre-defined violations can be corrected. Also, the systems and methods may use Artificial Intelligence (AI) or Machine Learning (ML) techniques for training ML models to perform certain functions, such as monitoring for non-compliance and automatically performing remedies.

Therefore, the present disclosure defines automated or semi-automated compliance managers and remediation managers. By enabling such a compliance manager to operate with close-loop automation, the systems and methods described herein may use AI and ML techniques to help enterprises a) monitor networks proactively, b) work on recommendations provided by the compliance manager, c) perform validation of NE configurations, d) synchronize device configurations as needed, among other functions. An enterprise network utilizing the closed-loop automation systems and methods of the present disclosure may thereby be equipped with a robust security compliance system and may greatly reduce the number of major non-compliant events in the network.

It may be noted, however, that enabling such a compliance manager in a network can be a complex task that requires crafting rules and policies and then running the compliance checks on the NEs. It may also be noted that compliance policies may apply to a single device or to a set of connected devices. Also, compliance policies and rules may be user-defined. For example, a user may define a rule that a certain type of interface of a NE should not be turned on, a rule that a Network Time Protocol (NTP) server should be used with certain NTP parameters turned on, or other specific user-defined rules.

Therefore, automation in the detection and remediation of non-compliant config data is a goal of the present embodiments. The present disclosure can automatically, and in real-time, perform compliance checks on NEs and other devices of the network using AI or ML techniques and then remediate potential non-compliant configurations in a fully automated manner.

There has thus been outlined, rather broadly, the features of the present disclosure in order that the detailed description may be better understood, and in order that the present contribution to the art may be better appreciated. There are additional features of the various embodiments that will be described herein. It is to be understood that the present disclosure is not limited to the details of construction and to the arrangements of the components set forth in the following description or illustrated in the drawings. Rather, the embodiments of the present disclosure may be capable of other implementations and configurations and may be practiced or carried out in various ways. Also, it is to be understood that the phraseology and terminology employed are for the purpose of description and should not be regarded as limiting.

As such, those skilled in the art will appreciate that the inventive conception, upon which this disclosure is based, may readily be utilized as a basis for the designing of other structures, methods, and systems for carrying out the several purposes described in the present disclosure. Those skilled in the art will understand that the embodiments may include various equivalent constructions insofar as they do not depart from the spirit and scope of the present invention. Additional aspects and advantages of the present disclosure will be apparent from the following detailed description of exemplary embodiments which are illustrated in the accompanying drawings.

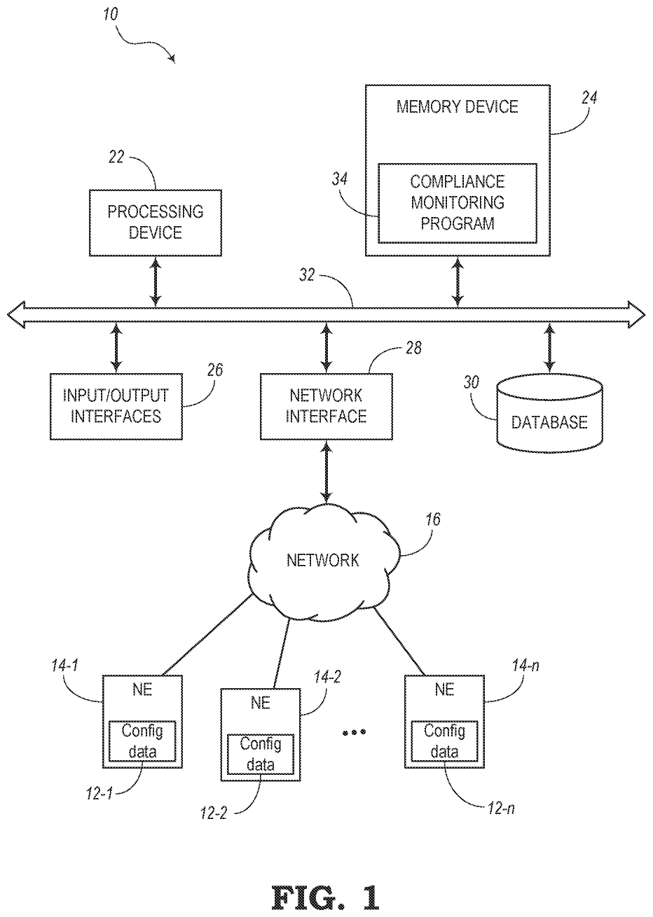

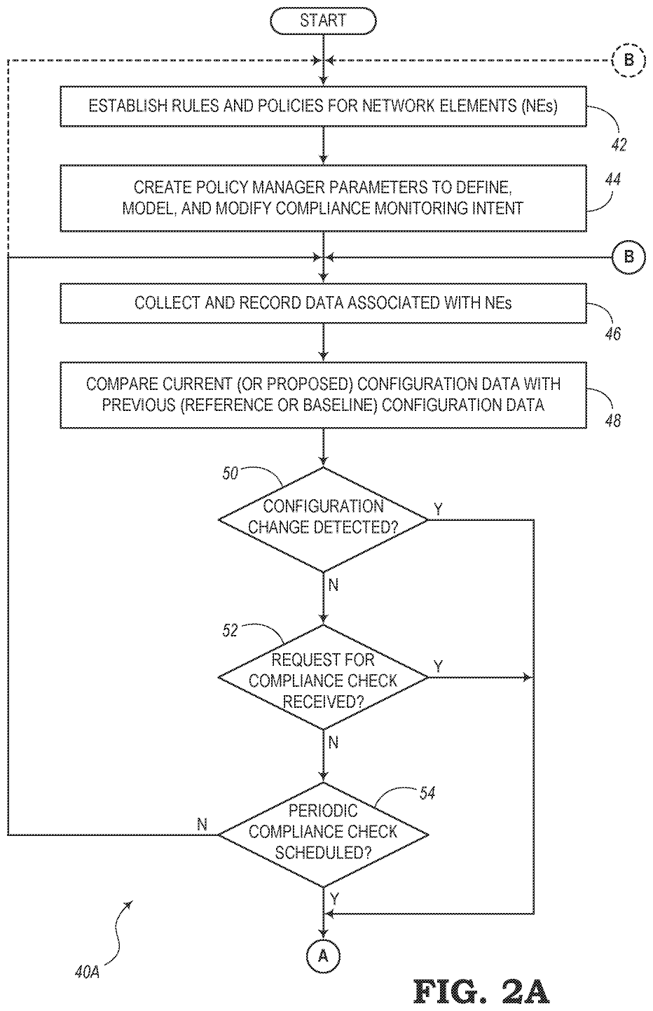

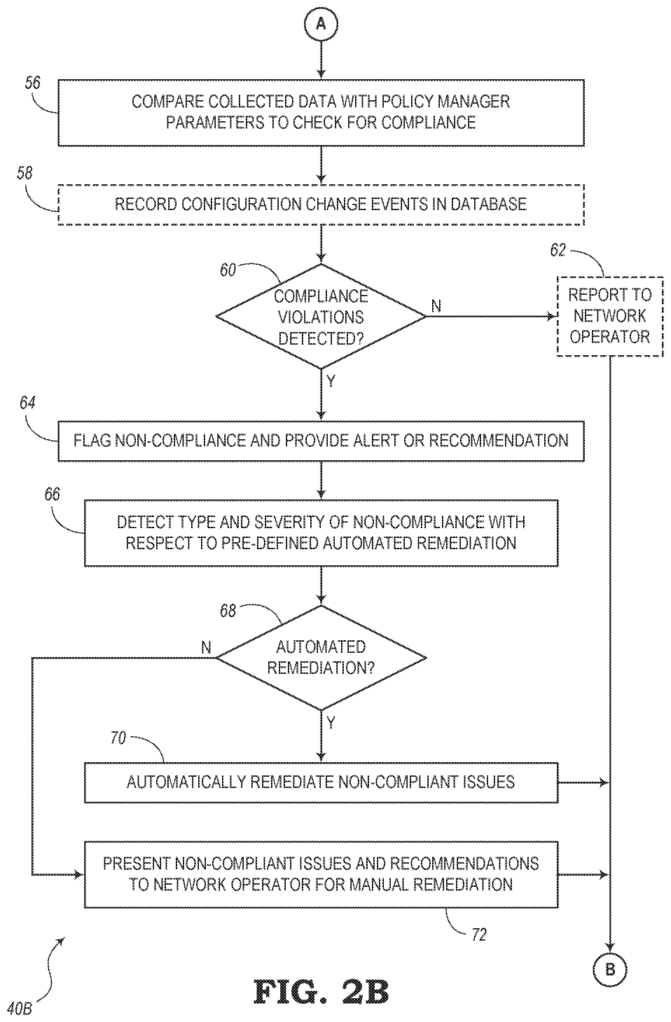

FIG. 1 is a block diagram illustrating an embodiment of a computer system 10 adapted to monitor configuration data 12-1, 12-2, . . . , 12-n (or config files) of a number of respective Network Elements (NEs) 14-1, 14-2, . . . , 14-n connected in a network 16 (e.g., enterprise network, Internet, etc.). In this respect, the computer system 10 may be a cloud-based system. By monitoring the config data 12 of each NE 14, the computer system 10 is adapted to determine if the config data 12 is compliant with respect to trust, reputation, legality, integrity, regulatory, and security criteria. The computer system 10 may execute any suitable compliance monitoring processes, such as those described below with respect to FIGS. 2-5.

The computer system 10 may be connected in the network 16 and may be configured as a control device that is able to control the NEs 14 of a particular network (e.g., enterprise network, network 16) or other networks. The computer system 10 may be a Network Monitoring System (NMS) or may be incorporated in an NMS. In this respect, the NMS may be adapted to push config changes to each NE 14 in the network for updating or modifying the config data 12 as needed.

In the illustrated embodiment, the computer system 10 may be a digital computing device that generally includes a processing device 22, a memory device 24, Input/Output (I/O) interfaces 26, a network interface 28, and a database 30. It should be appreciated that FIG. 1 depicts the computer system 10 in a simplified manner, where some embodiments may include additional components and suitably configured processing logic to support known or conventional operating features. The components (i.e., 22, 24, 26, 28, 30) may be communicatively coupled via a local interface 32. The local interface 32 may include, for example, one or more buses or other wired or wireless connections. The local interface 32 may also include controllers, buffers, caches, drivers, repeaters, receivers, among other elements, to enable communication. Further, the local interface 32 may include address, control, and/or data connections to enable appropriate communications among the components 22, 24, 26, 28, 30.

It should be appreciated that the processing device 22, according to some embodiments, may include or utilize one or more generic or specialized processors (e.g., microprocessors, CPUs, Digital Signal Processors (DSPs), Network Processors (NPs), Network Processing Units (NPUs), Graphics Processing Units (GPUs), Field Programmable Gate Arrays (FPGAs), semiconductor-based devices, chips, and the like). The processing device 22 may also include or utilize stored program instructions (e.g., stored in hardware, software, and/or firmware) for control of the computer system 10 by executing the program instructions to implement some or all of the functions of the systems and methods described herein. Alternatively, some or all functions may be implemented by a state machine that may not necessarily include stored program instructions, may be implemented in one or more Application Specific Integrated Circuits (ASICs), and/or may include functions that can be implemented as custom logic or circuitry. Of course, a combination of the aforementioned approaches may be used. For some of the embodiments described herein, a corresponding device in hardware (and optionally with software, firmware, and combinations thereof) can be referred to as “circuitry” or “logic” that is “configured to” or “adapted to” perform a set of operations, steps, methods, processes, algorithms, functions, techniques, etc., on digital and/or analog signals as described herein with respect to various embodiments.

The memory device 24 may include volatile memory elements (e.g., Random Access Memory (RAM), Dynamic RAM (DRAM), Synchronous DRAM (SDRAM), Static RAM (SRAM), and the like), nonvolatile memory elements (e.g., Read Only Memory (ROM), Programmable ROM (PROM), Erasable PROM (EPROM), Electrically-Erasable PROM (EEPROM), hard drive, tape, Compact Disc ROM (CD-ROM), and the like), or combinations thereof. Moreover, the memory device 24 may incorporate electronic, magnetic, optical, and/or other types of storage media. The memory device 24 may have a distributed architecture, where various components are situated remotely from one another, but can be accessed by the processing device 22.

The memory device 24 may include a data store, database (e.g., database 30), or the like, for storing data. In one example, the data store may be located internal to the computer system 10 and may include, for example, an internal hard drive connected to the local interface 32 in the computer system 10. Additionally, in another embodiment, the data store may be located external to the computer system 10 and may include, for example, an external hard drive connected to the Input/Output (I/O) interfaces 26 (e.g., SCSI or USB connection). In a further embodiment, the data store may be connected to the computer system 10 through a network and may include, for example, a network attached file server.

Software stored in the memory device 24 may include one or more programs, each of which may include an ordered listing of executable instructions for implementing logical functions. The software in the memory device 24 may also include a suitable Operating System (O/S) and one or more computer programs. The O/S essentially controls the execution of other computer programs, and provides scheduling, input/output control, file and data management, memory management, and communication control and related services. The computer programs may be configured to implement the various processes, algorithms, methods, techniques, etc. described herein.

Moreover, some embodiments may include non-transitory computer-readable media having instructions stored thereon for programming or enabling a computer, server, processor (e.g., processing device 22), circuit, appliance, device, etc. to perform functions as described herein. Examples of such non-transitory computer-readable medium may include a hard disk, an optical storage device, a magnetic storage device, a ROM, a PROM, an EPROM, an EEPROM, Flash memory, and the like. When stored in the non-transitory computer-readable medium, software can include instructions executable (e.g., by the processing device 22 or other suitable circuitry or logic). For example, when executed, the instructions may cause or enable the processing device 22 to perform a set of operations, steps, methods, processes, algorithms, functions, techniques, etc. as described herein according to various embodiments.

The methods, sequences, steps, techniques, and/or algorithms described in connection with the embodiments disclosed herein may be embodied directly in hardware, in software/firmware modules executed by a processor (e.g., processing device 22), or any suitable combination thereof. Software/firmware modules may reside in the memory device 24, memory controllers, Double Data Rate (DDR) memory, RAM, flash memory, ROM, PROM, EPROM, EEPROM, registers, hard disks, removable disks, CD-ROMs, or any other suitable storage medium.

Those skilled in the pertinent art will appreciate that various embodiments may be described in terms of logical blocks, modules, circuits, algorithms, steps, and sequences of actions, which may be performed or otherwise controlled with a general purpose processor, a DSP, an ASIC, an FPGA, programmable logic devices, discrete gates, transistor logic, discrete hardware components, elements associated with a computing device, controller, state machine, or any suitable combination thereof designed to perform or otherwise control the functions described herein.

The I/O interfaces 26 may be used to receive user input from and/or for providing system output to one or more devices or components. For example, user input may be received via one or more of a keyboard, a keypad, a touchpad, a mouse, and/or other input receiving devices. System outputs may be provided via a display device, monitor, User Interface (UI), Graphical User Interface (GUI), a printer, and/or other user output devices. I/O interfaces 26 may include, for example, one or more of a serial port, a parallel port, a Small Computer System Interface (SCSI), an Internet SCSI (iSCSI), an Advanced Technology Attachment (ATA), a Serial ATA (SATA), a fiber channel, InfiniBand, a Peripheral Component Interconnect (PCI), a PCI eXtended interface (PCI-X), a PCI Express interface (PCIe), an InfraRed (IR) interface, a Radio Frequency (RF) interface, and a Universal Serial Bus (USB) interface.

The network interface 28 may be used to enable the computer system 10 to communicate over a network, such as the network 16, the Internet, a Wide Area Network (WAN), a Local Area Network (LAN), and the like. The network interface 28 may include, for example, an Ethernet card or adapter (e.g., 10BaseT, Fast Ethernet, Gigabit Ethernet, 10GbE) or a Wireless LAN (WLAN) card or adapter (e.g., 802.11a/b/g/n/ac). The network interface 28 may include address, control, and/or data connections to enable appropriate communications on the network 16.

The computer system 10 further includes a compliance monitoring program 34. The compliance monitoring program 34 may be implemented in any suitable combination of hardware (e.g., in the processing device 22) and/or software/firmware (e.g., in the memory device 24). The compliance monitoring program 34 may include computer logic, code, one or more applications, etc., and may be adapted to enable or cause the processing device 22 to perform certain functionality related to the monitoring of config data and determining if the config data complies with predetermined criteria. If it is determined that the config data is non-compliant, the compliance monitoring program 34 may enable the processing device 22 to a) automatically perform remediation actions on the config data, and/or b) notify a network operator (e.g., via the I/O interfaces 26) of a non-compliance event and provide recommendations regarding the correction of the config data as needed to meet the compliance criteria.

FIGS. 2A and 2B, in combination, form a flow diagram illustrating an embodiment of a process 40 (i.e., labelled as 40A in FIG. 2A and 40B in FIG. 2B). The process 40 is adapted to monitor for network compliance of NE config files. As shown, the process 40 includes establishing rules and policies for NEs, as indicated in block 42. The rules and policies may be regular “out-of-the-box” rules or policies that may be used with a broad group of devices obtained from a standard library. In addition, the framework of the systems and methods of the present disclosure also allow for a user (e.g., technician, engineer, network administrator, etc.) to add their own rules and policies.

The process 40 also includes creating policy manager parameters to define, model, and/or modify compliance monitoring intent, as indicated in block 44. In some embodiments, AI may be used to discover these rules and policies and/or generate the rules to improve some area of rules compliance. Configuring policies and rules may be part of an ML training process. Then, the process 40 includes collecting and recording data associated with the NEs, as indicated in block 46. In some embodiments, the collecting step (block 46) may include collecting and leveraging policies and rules data from different customers, which can then be used to strengthen the AI for all customers. This might be especially advantageous for small to medium-sized companies since they might not have much data to train with. For a big company, however, some embodiments may include collecting the data from just this one company. However, in other embodiments, it may be helpful to use data from multiple enterprise networks to strengthen the ML training process in a supervised training procedure.

The collect data may be related to the configuration (config) data or config file associated with each device. The config information, for example, may include data with respect to NTP, https, services, etc. Next, the process 40 includes comparing current configuration data, or proposed configuration data (e.g., proposed by a network operator, network administrator, end user, IT technician, engineer, etc.), with previous configuration data (e.g., reference or baseline config data), as indicated in block 48. For example, this step may include using a command of “show config” for each device and then comparing this with a previous version or the latest stored version. The comparison is used to obtain a configuration difference, or “config diff.” In some embodiments, only the config diff may be collected and recorded in block 46, instead of dealing the whole config files.

The process 40 of FIGS. 2A and 2B further includes the step of determining if a configuration change has been detected, as indicated in condition block 50. If a configuration change is detected, the process 40 jumps ahead to block 56 (shown in FIG. 2B). Otherwise, the process 40 goes to condition block 52, which includes the step of determining if a request for a compliance check has been received (e.g., from a network operator). Again, this may be part of a supervised ML training process where config diff may be detected. When a user (e.g., network administrator) pushes a config change on a device and this is detected (e.g., condition block 50), then the compliance procedures, described below, can be performed to make sure the change complies with network policies and rules. In some embodiments, the config change may actually be a proposed change, which has not yet been put in place, but might be intercepted by the computer system 10 to automatically perform compliance checking in a preemptive manner to prevent misconfigurations from being applied.

If it is determined in condition block 52 that a specific request has been received, the process 40 jumps ahead to block 56. Otherwise, the process 40 goes to condition block 54, which includes the step of determining if a periodic compliance check has been scheduled. For example, the computer system 10 may include a scheduler that checks the config information on a regular basis and applies manually-defined rules, as needed. If a periodic check is scheduled, the process 40 goes to block 56. Otherwise, the process 40 returns back to block 46 to continue to collect (config) data. In some embodiments, particularly with respect to ML-based processes, the process may instead return back to block 42 to retrain a ML model by modifying rules and policies, as needed, and for adjusting policy manager parameters. Therefore, the real-time analysis of detecting a config diff is performed in condition block 50, according to preferred embodiments. In additional embodiments, specific requests for compliance checks or regularly scheduled compliance checks can also trigger these compliance checks, as described below.

As shown in FIG. 2B, the process 40 includes additional steps, starting with block 56, which represents any positive condition described in condition blocks 50, 52, 54 for prompting or triggering a compliance check. Block 56 includes the step of comparing the collected data with policy manager parameters to check for compliance. In some embodiments, the process 40 may also include the step of recording configuration change events in a database (e.g., database 30). Then, the process 40 includes the step of determining if any compliance violations have been detected, as indicated in condition block 60. If not, the process 40 may include the step of report a “compliant” status to the network operator, as indicated in block 62. At this point, the process 40 is configured to return to block 46, or, in embodiments regarding ML training, may return instead to block 42.

If it is determined in condition block 60 that compliance violations have been detected, then the process 40 includes proceeding to block 64, which includes the step of flagging a non-compliance condition and/or providing an alert or recommendation for compliance. Thus, according to the reporting steps of blocks 62, 64, compliance information can be stored to indicate whether a device has met the policies and rules, or the device has not met the policies and rules. This too can be used in the ML training process, using a first set of data to show what devices are properly configured and a second set of data to show what devices are not properly configured.

The process 40 further includes detecting a type and severity of non-compliance with respect to pre-defined automated remediation, as indicated in block 66. The process 40 further includes detecting if any remediated is predetermined as being performed automatically, as indicated in condition block 68. If so, the process 40 goes to block 70, which includes the step of automatically remediating the non-compliant issues. After that, the process 40 returns back to block 46 (or block 42) in a closed-loop control technique. If it is determined in condition block 68 that remediation is not to be automated for the specific non-compliant issues, then the process 40 jumps to block 72, which includes the step of presenting non-compliant issues and recommendations to a network operator to allow him or her to perform manual remediation, as needed. After this, the process 40 returns back to block 46 (or block 42) for the closed-loop implementation.

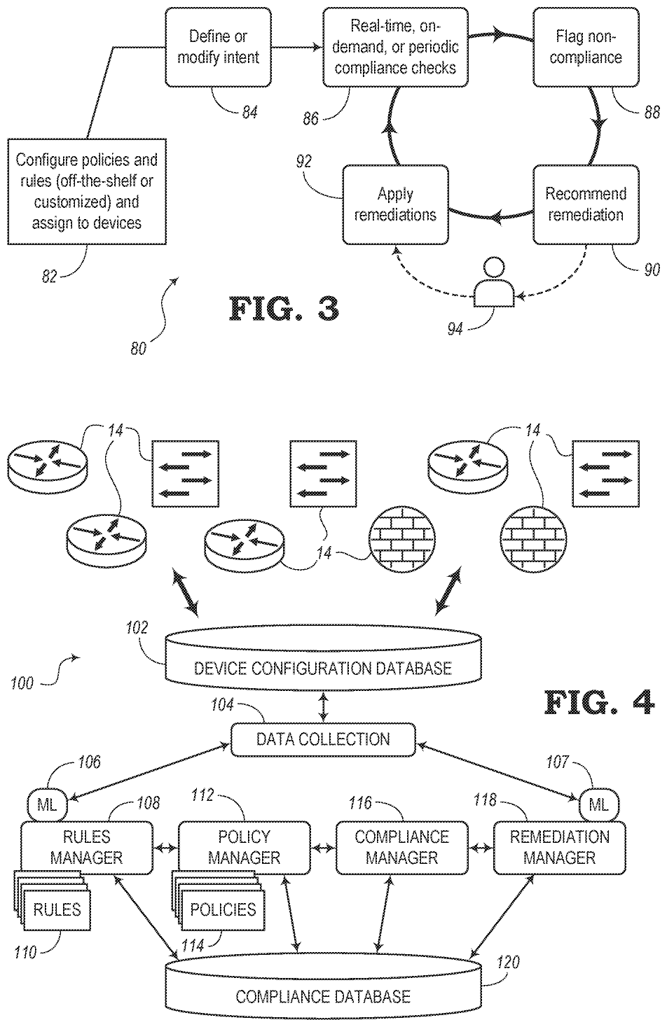

FIG. 3 is a diagram showing another embodiment of a process flow 80 for monitoring compliance and applying remediations. In a first step of the process flow 80, policies and rules may be configured, as indicated in block 82. The policies and rules may be either off-the-shelf standard policies and rules or customized policies and rules. Also, in block 82, the process flow 80 includes assigning these policies and rules to the devices (e.g., NEs) of the network in a deployment phase. Next, the process flow 80 includes a step of defining or modifying an intent, as indicated in block 84. The “intent,” as described herein, may be defined as a purposeful way of interpreting or employing the policies and rules for compliance detection.

In some embodiments, generating detection rules and corresponding compliance intents may utilize ML techniques. In one simple example, a network administrator may want to check if https is configured on certain devices. However, the steps associated with blocks 82 and 84 may involve more complex rules. In some cases, instead of relying on human expertise to write those expressions for certain rules or policies, the process flow 80 may use ML to generate the rules and policies. The steps of blocks 82 and 84 may also include the user-defined policies and rules in the situation where a user enters natural human language requirements or simple textual instructions. Using ML techniques, the process flow 80 may interpret these natural language rules and policies (e.g., “We want to check that https is enabled on this device”) and convert these instructions to a logical computer-readable expression of rules and policies.

After putting the policies and rules in place and defining the intent, block 86 of the process flow 80 includes performing real-time, on-demand and/or periodic compliance monitoring to check if the device met the various compliance requirements. The detection of the real-time state may be similar to the step of condition block 50 shown in FIG. 2A, the detection of the on-demand state may be similar to the step of condition block 52, and the detection of the periodic state may be similar to the step of condition block 54.

Then, the process flow 80 may include flagging non-compliance in one or more NEs, as indicated in block 88, which may be similar to block 64 shown in FIG. 2B. The process flow 80 further includes recommending remediation actions, as indicated in block 90. In the situation that the recommended actions are intended to be automatic, the process flow 80 includes the step of applying the remediations, as indicated in block 92. After this, the process flow 80 returns back to the block 86 to wait for the next compliance monitoring trigger. Also, if the recommended remediations of block 90 are not intended to be performed automatically, the process flow 80 may present the recommendations to a user 94 (e.g., network administrator, technician, network operator, engineer, etc.). When the user 94 receives this information, he or she may apply any suitable remediations as he or she see fit. These actions may be similar to blocks 68, 70, 72 of FIG. 2B.

As an example, if a user (e.g., network operator) is manually entering a modification to a config file of a device (e.g., using a CLI), the process flow 80 may be adapted to monitor the config changes (e.g., config diff) and determine immediately (i.e., in real time) if these changes follow the policies and rules. In some cases, the process flow 80 of the present disclosure may be able to detect non-compliant config changes while the user is entering the changes, even before they are actually applied to the devices. In this way, the process flow 80 can preempt any misconfiguration and provide warnings or alerts to the user that the proposed changes would result in non-compliance. Thus, the recommendation remediation step (block 90) may further include alerts of proposed config changes to warn the user that the changes may be a breach or violation of the security or regulatory policies and rules. Remediation actions may be taken (block 92) when it is determined that at least a portion of a config file is wrong.

The embodiments of the present disclosure may be adapted to leverage ML techniques to identify remediation action to be performed on non-compliant devices or events. This approach can be applied to any type of compliance issues that are running on the NEs (e.g., in an enterprise network). The computer system may be completely automated to perform the duties of compliance manager and remediation to non-compliant NEs and remove user dependency to enact identification and remediation of non-compliant events. In some embodiments, the computer system 10 may integrate non-compliant events with recommended actions for the user (e.g., IT engineer) to remediate issues in the network 16 and proactively monitor the network 16.

According to some embodiments, the process flow 80 may include multi-step AI-based solutions. For example, the process flow 80 may include:
1. Modeling compliance intent (block 84) across multi-vendor, multi-domain networks;
2. Detecting in real-time any configuration changes made on a device, whether the changes were configured directly on the device (e.g., via CLI, API, or the like) or using an external tool such as a Network Configuration Management (NCM) tool of a Network Management System (NMS). Configuration change monitoring may also be performed on a regular schedule (e.g., using a scheduler, such as Tron, etc.);
3. Once a configuration change is detected, checking compliance of the config files, which may include using heuristics, manually-defined compliance rules, ML techniques, or other means;
4. Recommending remediation actions (and optionally automatically executing them without human input); and
5. Learning which configuration changes are likely to trigger compliance violations and proactively notify users before they push “risky” configurations or known non-compliant configs to the devices.

### Intent Definition

Referring again to block 84, the defining or modifying of the intent may include, as an initial step before compliance monitoring, defining a purpose or objective to run the compliance check on the NEs or devices. Block 84 may include a solution using an engine that can combine a manually-defined set of rules and supervised ML models.

The compliance policies created in block 82 may include associating one or more rules or ML models with an intent, such as, for example:
1. Simpler intents may be represented using a single rule or ML model;
2. More complex intents can be represented with more sophisticated hybrid combinations of the behavioral heuristics and ML models described below, for example, using logical expressions or more complex nested modelling techniques; and
3. Additional meta information about the device.

It may be noted that compliance policies may apply to single device configurations or multiple devices used together. For instance, two devices may be compliant individually, but may violate a policy when they are connected together in the same network. In addition, a device compliant in one region or territory may not be compliant in another region or territory. For instance, different countries may have different regulations for different rules and policies (e.g., the allowable maximum strength of encryption keys). Also, as mentioned above, these policies are not necessarily limited to configuration information, but may also be applicable to other aspects, such as end-of-life information monitoring, support notifications from vendors, expiration dates of licenses, firmware version information, backup status information, etc.

With reference to compliance rules (block 82), the rules/heuristics can easily represent the compliance behavior of a single device type. In one example of a spanning tree configuration on a device, an objective may be to verify if the spanning tree configuration on the device (i.e., intent) is to check whether the devices in the network are compliant to standards of the spanning tree configuration. In some cases, this rule may be created by using:
/.*spanning-tree mode (rapid-)?pvst.*/g

Rules created using a rule manager may indicate that the device configuration must contain configuration lines “spanning-tree mode rapid-pvst” or “spanning-tree mode pvst.” Modelling intent (block 84) across multi-vendor device families may be important for typical enterprise networks and may typically require numerous vendor-specific rules or more advanced ML approaches, some of which are described below.

The rule configuring step (block 82) may also include “Rule Generation Using ML.” Given enough historical configuration changes, the computer system 10 may automatically generate rules, such as by using deep learning techniques based on Generative Adversarial Networks (GANs) and deep Natural Language Processing (NLP) techniques such as Bidirectional Encoder Representations from Transformers (BERT) models. Those models may be well-suited to generate sequences of text and may be introduced for keyword suggestions and conversational chatbots.

In some embodiments, the ML models may be trained using historical device configuration information and compliance event information to generate rules, such as the ones described above. Given some historical textual description (e.g., in plain language) of the configuration changes, the computer system 10 may be able to train a generative ML model to automatically generate rules from plain language (e.g., plain English). For instance, given the string “The device should allow multiple spanning trees,” the ML model may be adapted to return “spanning-tree mode pvst,” which can be readily and programmatically used by the compliance module as described below.

The rule configuring step (block 82) may also include “ML modelling.” In some cases, using rules to represent intent may not be practical, because of the complexity of the intent, or because of the number of policies or devices. In this case, the computer system 10 may leverage supervised learning techniques to automatically learn if a configuration is compliant or not.

To reduce noise, input data may correspond to incremental configuration changes rather than raw configurations. Those incremental configurations may be preprocessed using NLP techniques, such as stemming and lemmatization to further reduce noise. The labels may be binary (i.e., compliant or non-compliant), which allows the computer system 10 to apply a wide variety of binary ML algorithms (e.g., Deep Neural Network (DNNs), XGBoost, etc.).

### Data Collection

FIG. 4 illustrates another embodiment of a system 100 for collecting data with respect to configuration information of a number of NEs and determining compliance of the configuration data. In the present disclosure, it may be assumed that the availability of a data collection system (e.g., assurance software, analytics software, configuration analysis software, etc.) that can be used to collect relevant data from NEs may include configuration backup files, configuration changes pushed to the device, syslog data, user login and logout events, real-time device configuration information, and the like. The data may be fetched from a customer's premises. The historic data from the customer's devices may include configuration backups, config change requests, user login and logout events, commands executed on the devices, syslog events, etc. This may also include data from past compliance check events, such as devices with compliant and non-compliant policies.

The system 100 of FIG. 4 includes NEs 14 or other devices of a network or portion of a network. The NEs 14, for example, may include routers, switches, firewall devices, etc. Data related to config information may be obtained from these NEs 14 and stored in a device configuration database 102, which may be the same as or similar to the database 30 shown in FIG. 1. A data collection module 104 is configured to receive config data from the device configuration database 102. Using ML models 106, 107, the collected data is applied to a rules manager 108 having a number of rules 110, a policy manager 112 having a number of policies 114, a compliance manager 116, and a remediation manager 118. The rules manager 108, policy manager 112, compliance manager 116, and remediation manager 118 may be adapted to perform certain functions corresponding to the policies and rules creation steps, compliance monitoring steps, and remediation steps described in various implementation throughout the present disclosure. The resulting information and data from the rules manager 108, policy manager 112, compliance manager 116, and remediation manager 118 are stored in a compliance database 120, which may be the same as or similar to the databases 30, 102.

### Real-Time Compliance Check

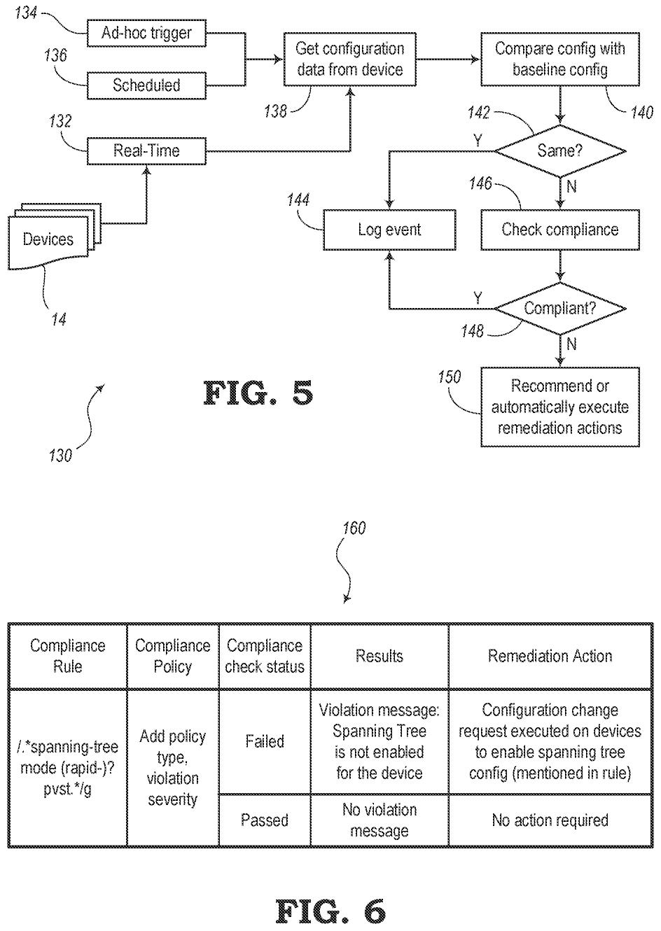

FIG. 5 shows another embodiment of a process flow 130 for comparing config data with baseline config data based on responses to different triggers. In a preferred embodiment, compliance monitoring may be performed in response to a “real-time” trigger 132 by continually or periodically monitoring NEs 14 or devices, without any external prompts. In other cases, an ad-hoc trigger 134 may include receiving a request from a user (e.g., network administrator) or responding to a scheduled prompt 136 for monitoring compliance according to a predetermined schedule. Once a request, prompt, or trigger is received for triggering the compliance check, the process flow 130 goes to block 138, which includes the step of getting configuration data from the device under test.

The process flow 130 includes comparing the configuration with a baseline configuration, such as a previously stored version of the config file for the device under test. If the config files are the same, as tested in condition block 142, then the process flow 130 may be adapted to log the event (block 144) for later use. However, if there is a config diff (i.e., the config is not the same as the baseline config as tested in condition block 142), then the process flow 130 proceeds to block 146, which includes the step of checking whether this config change is compliant with the pre-established rules and policies. If it is compliant, this information can be logged in the log event step 144. Otherwise, if the config change is non-compliant, the process flow 130 includes the step of recommending or automatically executing one or more remediation actions, as indicated in block 150.

As suggested in block 66 shown in FIG. 2B, every compliance policy may have some violation “severity,” where the penalties for not adhering to the compliance policies may vary based on the severity. If a device violates any particular compliance check, the non-compliant device might fall under any number of violation severity classed. For example, some classes of non-compliance severity may include “minor,” “major,” “critical,” and others. In some embodiments, the computer system 10 may have an “actor-based” compliance framework that relies on stateless asynchronous processing. The computer system 10 may rely on a mechanism of queues to ensure that it can be efficiently distributed in a cluster and handle large scale networks. This may include scenarios to support Internet of Things (IoT) use-cases where millions of devices may be connected in multiple locations.

Compliance checks (e.g., block 146) can be triggered using different mechanisms depending on the scenario:

1) On-demand

Users can run compliance checks on devices or NEs 14 whenever needed. Once a compliance check executes on a set of devices or NEs 14, the computer system 10 may scan the devices with the rules mentioned in the compliance policy and publish the results as to whether the device satisfies the condition mentioned in the policy or not.

2) Scheduled check

Users can schedule regular compliance checks on multiple devices. This can be done daily, weekly, monthly, or according to any suitable timeframe, depending on the user's requirement. In some embodiments, the frequency of compliance checks can be set beforehand. Performing repeated checks can be helpful to get regular fresh insights into device configurations, device compliance states, etc. The computer system 10 may provide a notification to the users for scheduled compliance checks, so that when the compliance check is completed, the user will be notified about the results.

3) Real-time compliance check

For critical compliance policies (e.g., related to security), it may be necessary to check compliance of new configurations in real-time, whenever a change is being proposed or when it is first uploaded to a device. When the computer system 10 is implemented in an NMS, real-time compliance checks can be achieved by simply checking the configuration when a user configures devices using the NMS itself. However, when configs are changed by other mechanisms (e.g., external system, via CLI directly, etc.), the computer system 10 may communicate with the devices or NEs on a regular basis to check for any config changes. The computer system 10 may support these frequent CLI-based configuration changes, which may be important for audits and compliance purposes.

Referring again to FIG. 5, the framework of the process flow 130 may be adapted to monitor when users login and logout with respect to devices. This monitoring may be done using events traps generated from the devices and can detect in real-time whenever a user logs out of a device. When the computer system 10 detects a logout event, it may fetch the configuration from the device, compare it with the baseline configuration in the database 30, 102. If the configuration is different, the computer system 10 can then automatically check if the new configuration is compliant. All events, whether compliant or not, as well as new configurations, may be persisted in the database 30, 120 for audit purposes. In this way, the process flow 130 can help network admin in getting the device configuration validated against compliance policies in real time. When established for automated execution, the admin does not need to run compliance checks manually on the devices whenever the admin modifies configuration data on the devices. In this way, the computer system 10 can help the network admin to keep up to date on regulatory compliance checks.

### Automated Remediation

Once a compliance violation has been detected, it makes sense to have this violation fixed quickly. Remediation events may be fully automated, or they may optionally require user confirmation before being applied to the network. The recommended action may be based on the rules, policies, and/or heuristics. For instance, each compliance policy may be associated with a configuration template that may be applied whenever the policy is violated.

If the number of policies or configuration templates is significant, manually defining rules may not practical. In that case, the computer system 10 may be adapted to automatically learn and suggest remediation actions using collaborative filtering algorithms and supervised ML models. Here, the supervised ML model may be a multi-class classifier (e.g., one class per possible remediation template). The classifier may be trained to predict which template is best to remediate a certain policy violation. Reinforcement learning techniques may also be used for more complex scenarios, such as, for instance, when multiple templates are needed to remediate the violation or when multiple devices may be impacted. In that case, the reward function may be derived from a compliance score based on the policy type, violation severity, and other metrics.

FIG. 6 is a table 160 illustrating an example of remediation actions based on a pass or fail compliance check.

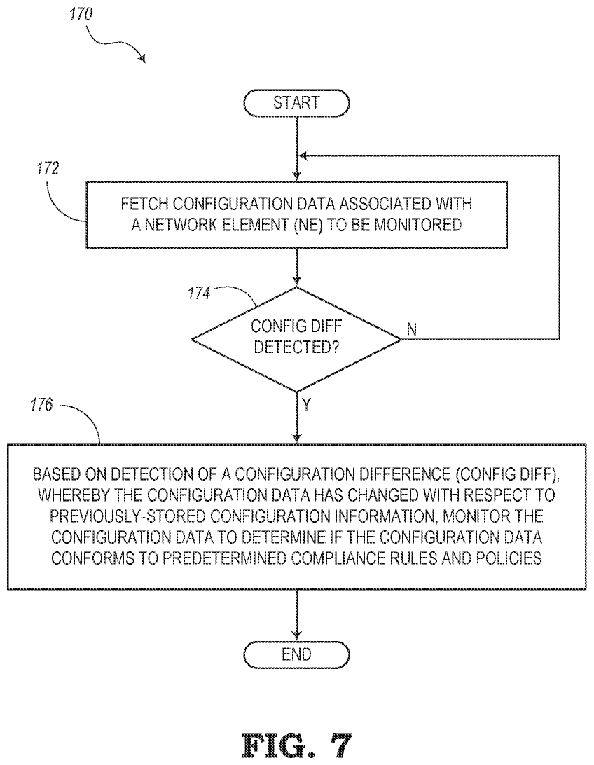

FIG. 7 is a flow diagram illustrating a process 170, described in general terms, for monitoring compliance of configuration changes in NEs. As illustrated in FIG. 7, the process 170 includes the step of fetching configuration data associated with a Network Element (NE) to be monitored, as indicated in block 172. The process 170 further includes detecting whether the configuration data has changed with respect to previously-stored configuration information, as indicated in condition block 174. If not, the process 170 returns back to block 172 until it is determined that the configuration data has changed. Based on detection of a configuration difference (config diff), whereby the configuration data has changed with respect to previously-stored configuration information, the process 170 further includes the step of monitoring the configuration data to determine if the configuration data conforms to predetermined compliance rules and policies, as indicated in block 176.

According to additional embodiments, the process 170 may be further defined. For example, the step of fetching the configuration data (block 172) may be executed in response to receiving a trigger. For example, the trigger may be a) a real-time trigger involving observing user behavior with respect to the NE to be monitored, b) an on-demand trigger in which the user requests a compliance check, and/or c) a scheduled trigger in which compliance checks are performed at regularly scheduled times.

In response to determining that the configuration data is non-compliant, the process 170 may further include the step of automatically performing one or more remediation actions on the configuration data to reach a compliant state. Alternatively, in response to determining that the configuration data is non-compliant, the process 170 may instead provide one or more recommendations to a network operator regarding remediation actions.

In some embodiments, the process 170 may utilize Machine Learning (ML) techniques to train a ML model to establish or modify the predetermined compliance rules and policies. Also, the process 170 may include utilizing ML techniques to perform one or more functions including a) monitoring the configuration data of multiple NEs, b) synchronizing configuration files between two or more of the multiple NEs, c) calculating the configuration difference, d) performing compliance checks, e) performing remediation actions for non-compliant NEs, and/or f) providing remediation recommendations to a user.

Furthermore, the process 170 may also include the steps of establishing compliance rules and policies for a plurality of NEs in a network and defining an intent to perform compliance monitoring with respect to the compliance rules and policies. If the configuration data does not conform to the predetermined compliance rules and policies, the process 170 may determine the type and severity of the non-compliance. The process 170 may be associated with a system (e.g., computing system 10) and/or non-transitory computer-readable media (e.g., compliance monitoring program 34). In some embodiments, this system may include a processing device and memory and may perform the functions or steps of the process 170. Also, the system may further include a database configured to store configuration information and/or compliance information.

Therefore, the embodiments of the systems and methods of the present disclosure are configured to overcome many of the deficiencies of the conventional systems. For example, the present embodiments may use novel multi-step, end-to-end solutions (e.g., including data collection, policy manager, compliance checking, etc.). As a result of non-compliance detection, the systems and methods may then provide automated remediation actions to automatically remediate compliance violations.

Also, the utilization of ML techniques is believed to be novel with respect to conventional compliance checking systems. The ML models of the present disclosure are configured to predict compliance status. The ML models can also be trained using historical configuration data and features such as a) configuration files (e.g., commands used in config files, raw configurations or incremental configuration changes, versions of config files stored on system, date and time of backed up config files, baseline versions), node information (e.g., node name, vendor, model number, location of the node, such as site, country, etc.), and user (e.g., network administrator) information (e.g., user login and logout events from nodes via syslog information, user information from users who made changes to config via tools, etc.).

Another point of novelty in the present disclosure is the intent-based compliance modelling. For example, using rules automatically generated by ML models (e.g., GANs, BERTs, etc.), rules may be generated using ML from configuration drifts or rules may be generated using ML from textual description (e.g., description in plain text English). Intent-based compliance modelling may also include using supervised ML to automatically predict if configuration changes are compliant or not and/or using logical and/or hierarchical modelling that can combine existing rules defined by a SME and the above techniques.

Also, the present disclosure includes advantages over the conventional systems, where detection may be made “in real-time” with respect to configuration changes. This real-time detection may be applicable to users of the present systems and methods and/or user of external systems (e.g., CLIs for configure devices), by detecting logout events and comparing resulting configurations with the reference configuration. The methods may detect compliance violations in real-time and predict remediation actions to non-compliant events, such as by using a) rules manually defined by SME to map each policy to a remediation template, b) collaborative filtering algorithms to predict which template can best remediate a given violation based on historical data, c) supervised ML to predict which template can best remediate a given violation, d) reinforcement learning algorithms for more complex scenarios, to predict a sequence of remediations actions on one or several devices, among others.

Furthermore, the present disclosure also provides novelty with respect to methods that can combine real-time compliance violation detection from above together with the methods described herein, particularly in a close-loop system for automated remediations. Also, proactive alerts may be provided if ML models detect a configuration change likely to trigger non-compliance violations. For example, these non-compliant configurations may be proactively blocked before being pushed to the devices. Also, the non-Compliant configurations may be automatically quarantined and may require additional review by a SME before being pushed to the device.

Although the present disclosure has been illustrated and described herein with reference to various embodiments and examples, it will be readily apparent to those of ordinary skill in the art that other embodiments and examples may perform similar functions, achieve like results, and/or provide other advantages. Modifications, additions, or omissions may be made to the systems, apparatuses, and methods described herein without departing from the spirit and scope of the present disclosure. All equivalent or alternative embodiments that fall within the spirit and scope of the present disclosure are contemplated thereby and are intended to be covered by the following claims.

What is claimed is:

1. A non-transitory computer-readable medium configured to store computer logic having instructions that, when executed, cause one or more processing devices to:
fetch configuration data associated with a Network Element (NE) to be monitored, and
based on detection of a configuration difference whereby the configuration data has changed with respect to previously-stored configuration information, monitor the configuration data to determine if the configuration data conforms to predetermined compliance rules and policies.

2. The non-transitory computer-readable medium of claim 1, wherein fetching the configuration data is executed in response to receiving a trigger.

3. The non-transitory computer-readable medium of claim 2, wherein the trigger is one or more of a real-time trigger involving observing user behavior with respect to the NE to be monitored, an on-demand trigger in which the user requests a compliance check, and a schedule trigger in which compliance checks are performed at regularly scheduled times.

4. The non-transitory computer-readable medium of claim 1, wherein, in response to determining that the configuration data is non-compliant, the instructions further cause the one or more processing devices to automatically perform one or more remediation actions on the configuration data to reach a compliant state.

5. The non-transitory computer-readable medium of claim 1, wherein, in response to determining that the configuration data is non-compliant, the instructions further cause the one or more processing devices to provide one or more recommendations to a network operator regarding remediation actions.

6. The non-transitory computer-readable medium of claim 1, wherein the instructions further enable the one or more processing devices to utilize Machine Learning (ML) techniques to train a ML model to establish or modify the predetermined compliance rules and policies.

7. The non-transitory computer-readable medium of claim 6, wherein the instructions further enable the one or more processing devices to utilize ML techniques to perform one or more functions including monitoring the configuration data of multiple NEs, synchronizing configuration files between two or more of the multiple NEs, calculating the configuration difference, performing compliance checks, performing remediation actions for non-compliant NEs, and providing remediation recommendations to a user.

8. The non-transitory computer-readable medium of claim 1, wherein the instructions further enable the one or more processing devices to establish compliance rules and policies for a plurality of NEs in a network and define an intent to perform compliance monitoring with respect to the compliance rules and policies.

9. The non-transitory computer-readable medium of claim 1, wherein, if the configuration data does not conform to the predetermined compliance rules and policies, the instructions further enable the one or more processing devices to determine type and severity of non-compliance.

10. The non-transitory computer-readable medium of claim 1, wherein the instructions further enable the one or more processing devices to store configuration information and/or compliance information in a database.

11. A system comprising:
a processing device, and
a memory device configured to store a computer program having instructions that, when executed, enable the processing device to
fetch configuration data associated with a Network Element (NE) to be monitored, and
based on detection of a configuration difference whereby the configuration data has changed with respect to previously-stored configuration information, monitor the configuration data to determine if the configuration data conforms to predetermined compliance rules and policies.

12. The system of claim 11, wherein fetching the configuration data is executed in response to receiving a trigger.

13. The system of claim 12, wherein the trigger is one or more of a real-time trigger involving observing user behavior with respect to the NE to be monitored, an on-demand trigger in which the user requests a compliance check, and a scheduled trigger in which compliance checks are performed at regularly scheduled times.

14. The system of claim 11, wherein, in response to determining that the configuration data is non-compliant, the instructions further enable the processing device to automatically perform one or more remediation actions on the configuration data to reach a compliant state.

15. The system of claim 11, wherein, in response to determining that the configuration data is non-compliant, the instructions further enable the processing device to provide one or more recommendations to a network operator regarding remediation actions.

16. A method comprising the steps of:
fetching configuration data associated with a Network Element (NE) to be monitored, and
based on detection of a configuration difference whereby the configuration data has changed with respect to previously-stored configuration information, monitoring the configuration data to determine if the configuration data conforms to predetermined compliance rules and policies.

17. The method of claim 16, further comprising the step of utilizing Machine Learning (ML) techniques to train a ML model to establish or modify the predetermined compliance rules and policies.

18. The method of claim 17, further comprising the step of utilizing ML techniques to perform one or more functions including monitoring the configuration data of multiple NEs, synchronizing configuration files between two or more of the multiple NEs, calculating the configuration difference, performing compliance checks, performing remediation actions for non-compliant NEs, and providing remediation recommendations to a user.

19. The method of claim 16, further comprising the steps of
establishing compliance rules and policies for a plurality of NEs in a network, and
defining an intent to perform compliance monitoring with respect to the compliance rules and policies.

20. The method of claim 16, further comprising the step of determining a type and severity of non-compliance when the configuration data does not conform to the predetermined compliance rules and policies.
